(19) United States
(12) Patent Application Publication
(10) Pub. No.: US 2004/0125951 A1
(43) Pub. Date: Jul. 1, 2004

(54) Bitstreaming for unreadable redundancy

(75) Inventors: Timothy Dunn, San Jose, CA (US); Jos L. Marlowe, Mountain View, CA (US)

Correspondence Address: David B. Ritchie, THELEN REID & PRIEST LLP, P.O. BOX 640640, San Jose, CA, 95164-0640, US

(73) Assignee: Sun Microsystems, Inc., a Delaware Corporation

(21) Appl. No.: 10/330,620

(22) Filed: Dec. 26, 2002

(51) Int. Cl. H04L 9/00

(52) U.S. Cl. 380/42

(57) ABSTRACT

A stream-based cipher may be used to bitstream a data file into multiple files. Each file is incomplete and therefore unreadable without knowing the other files that must be used to reconstruct the original file. A central registry may be maintained which indicates which files are together. Files may be reconstructed by brute force computing once all the files are retrieved, eliminating the need for any indication of how to reassemble the files to be transmitted. By using such a system, authorities (either governmental or corporate) are prevented from casually examining a file for content or even for file format. The files will simply appear as random data.

### FIELD OF THE INVENTION

The present invention relates to the field of data encryption. More particularly, the present invention relates to the bitstreaming of data for unreadable redundancy.

### BACKGROUND OF THE INVENTION

Certain types of data files may incur the wrath of large and powerful groups or governments. For example, certain repressive governments regularly police Internet usage in an attempt to subvert any political or religious movements from transmitting information.

These large organizations or governments typically use a red-flagging system to detect offending data. In a red-flagging system, computers scan data transmissions to look for suspicious words or phrases. While encrypting the data will often prevent these entities from reading its contents, they have responded by treating anything but bare text as “suspicious” and either preventing its transmission or more closely monitoring the sender and recipient of the encrypted data.

Therefore, what is needed is a solution that prevents such entities from reading the contents of the data

### BRIEF DESCRIPTION

A stream-based cipher may be used to bitstream a data file into multiple files. Each file is incomplete and therefore unreadable without knowing the other files that must be used to reconstruct the original file. A central registry may be maintained which indicates which files are together. Files may be reconstructed by brute force computing once all the files are retrieved, eliminating the need for any indication of how to reassemble the files to be transmitted. By using such a system, authorities (either governmental or corporate) are prevented from casually examining a file for content or even for file format. The files will simply appear as random data.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a flow diagram illustrating a method for bitstreaming a data file in accordance with an embodiment of the present invention.

FIG. 2 is a flow diagram illustrating a method for bitstreaming a data file in accordance with another embodiment of the present invention.

FIG. 3 is a flow diagram illustrating a method for retrieving a file in a computer network in accordance with an embodiment of the present invention.

FIG. 4 is a flow diagram illustrating a method for retrieving a file in a computer network in accordance with another embodiment of the present invention.

FIG. 5 is an example is provided in order to illustrate how the present invention may work.

FIG. 6 is another example is provided in order to illustrate how the present invention may work.

FIG. 7 is a block diagram illustrating an apparatus for bitstreaming a data file in accordance with an embodiment of the present invention.

FIG. 8 is a block diagram illustrating an apparatus for bitstreaming a data file in accordance with another embodiment of the present invention.

FIG. 9 is a block diagram illustrating an apparatus for retrieving a file in a computer network in accordance with an embodiment of the present invention.

FIG. 10 is a block diagram illustrating an apparatus for retrieving a file in a computer network in accordance with another embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention utilizes a stream-based cipher to bitstream a data file into multiple files. Each file is incomplete and therefore unreadable without knowing the other files that must be used to reconstruct the original file. A central registry may be maintained which indicates which files are together. Files may be reconstructed by brute force computing once all the files are retrieved, eliminating the need for any indication of how to reassemble the files to be transmitted. By using such a system, authorities (either governmental or corporate) are prevented from casually examining a file for content or even for file format. The files will simply appear as noise. Thus, while normal encryption is designed to prevent anyone but a small number of people from accessing a file, the encryption of the present invention is very useful in ensuring that content providers are protected while ensuring the ability of large numbers of individuals (but not corporations or governments) can access the content.

Typical ciphers are block-based. A block-based cipher takes a set of bit strings of length n and applies an encryption algorithm that creates a permutation of the set of bit strings for each key. A common block-based cipher is the Data Encryption Standard (DES). DES takes a 64-bit chunk and compresses it to a 56-bit block. DES and other ciphers split the data widht-wise only. If one views a block as a one-dimensional array of characters, each block is simply created by taking the next set of characters that equal the block size. So if, for example, a file of 20 characters (viewed in a 1×20 array) was encoded with a block-based cipher having a block size of 5, the first 5 characters would be in block 1, the second 5 in block 2, the third 5 in block 3, and the last 5 in block 4. The present invention, however, splits up a data file both width-wise and length-wise. This may be exemplified by a two dimensional array of characters. Thus, the same 20 character file may be viewed as a two dimensional 4×5 array, and the file may then be characters taken off to be placed in a particular file would be chosen not just by their horizontal position but by their vertical position as well. An example will be provided later in this disclosure that will illustrate this fact.

In a specific embodiment of the present invention, every 8th bit (from an offset of n, where 0<=n<=7) of a data file is taken for each file. Additionally, to provide for data integrity, an additional 3 bits may be added to the end of each byte to allow for Huffman error correction, resulting in 11 separate files for each incoming data file. One of ordinary skill in the art will recognize that other configurations are possible as well, and nothing in this disclosure should be read as limiting embodiments to an 11-file configuration.

A central registry may be utilized which then indicates which 11 files are grouped together. The central registry may also keep MD5 checksums on file to ensure that files are not tampered with or are dummy files. The MD5 checksums may be posted on the same server in the same file tree as the file. Each of the files may be stored in a different location, perhaps even on a different server controlled by a different Internet Service Provider or company. This reduces the liability of any particular company since they may not be storing an entire data file.

The files may be mirrored, perhaps by peer-to-peer automated systems, further compounding the integrity and availability of the original file. This solution does not require much processing on the client side, yet still provides a lot of protection. Additionally, the “encoded” files will not appear to be encoded, but merely appear to be gibberish, thus appearing as noise to any entities monitoring transmissions.

The present invention also has the advantage of being able to protect messages inside the United States based on U.S. law. The Digital Millennium Copyright Act (DMCA) prevents the breaking of encrypted copyrighted material by private parties using decryption or reverse-engineering. Thus, any U.S. company attempting to decrypt these messages is committing copyright infringement and can be sued.

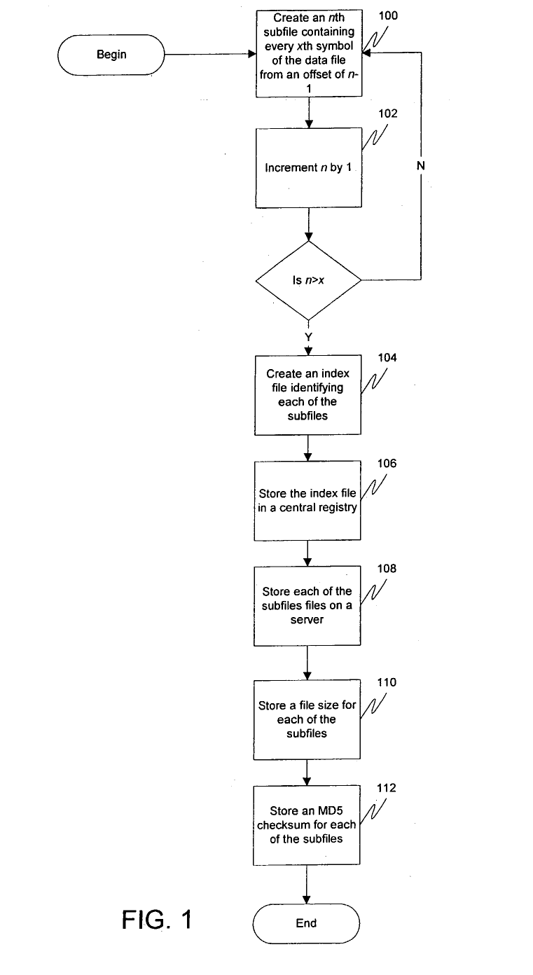

FIG. 1 is a flow diagram illustrating a method for bitstreaming a data file in accordance with an embodiment of the present invention. A bitstreaming size (the number of subfiles that will be generated from a file) may be represented by x with n being a counter initially set to 1. At 100, an nth subfile containing every xth symbol of the data file from an offset of n−1 may be created. The term symbol is intended to indicate any sized data set. Typically, each symbol will be a bit, therefore the data file is bitstreamed by taking every xth bit, but one of ordinary skill in the art will recognize that the symbol may be of a different size, such as a byte or a character.

At 102, n maybe incremented by 1. The creating 100 and incrementing 102 may be repeated until n>x. At 104, an index file identifying each of the subfiles may be created. The index file may further indicate the location of each subfile, if that is not readily apparent from the identification. At 106, the index file may be stored in a central registry. At 108, each of the subfiles may be stored on a server. At 110, a file size for each of the subfiles may be stored on the server. At 112, an MD5 checksum may be stored for each of the subfiles.

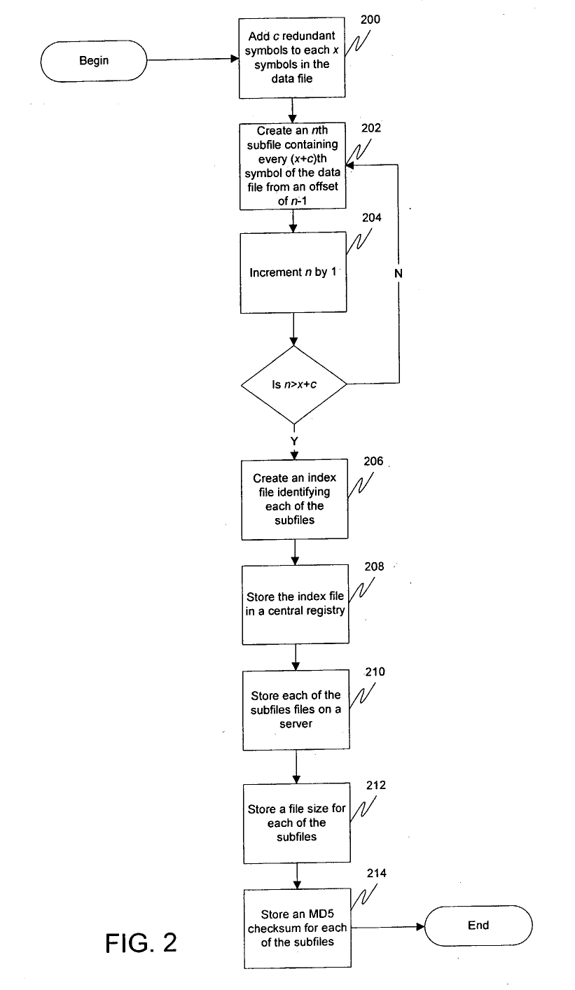

FIG. 2 is a flow diagram illustrating a method for bitstreaming a data file in accordance with another embodiment of the present invention. In this embodiment, error-correcting capabilities are provided through a Huffman algorithm. A bitstreaming size (the number of subfiles that will be generated from a file) may be represented by x with n being a counter initially set to 1. A number of symbols to add in order to provide error-correcting capabilities may be denoted as c. At 200, c redundant symbols may be added to each x symbols in the data file. At 202, an nth subfile containing every (x+c)th symbol of the data file from an offset of n−1 may be created. The term symbol is intended to indicate any sized data set. Typically, each symbol will be a bit, therefore the data file is bitstreamed by taking every (x+c)th bit, but one of ordinary skill in the art will recognize that the symbol may be of a different size, such as a byte or a character.

At 204, n maybe incremented by 1. The creating 200 and incrementing 202 may be repeated until n>x+c. At 206, an index file identifying each of the subfiles may be created. The index file may further indicate the location of each subfile, if that is not readily apparent from the identification. At 208, the index file may be stored in a central registry. At 210, each of the subfiles may be stored on a server. At 212, a file size for each of the subfiles may be stored on the server. At 214, an MD5 checksum may be stored for each of the subfiles.

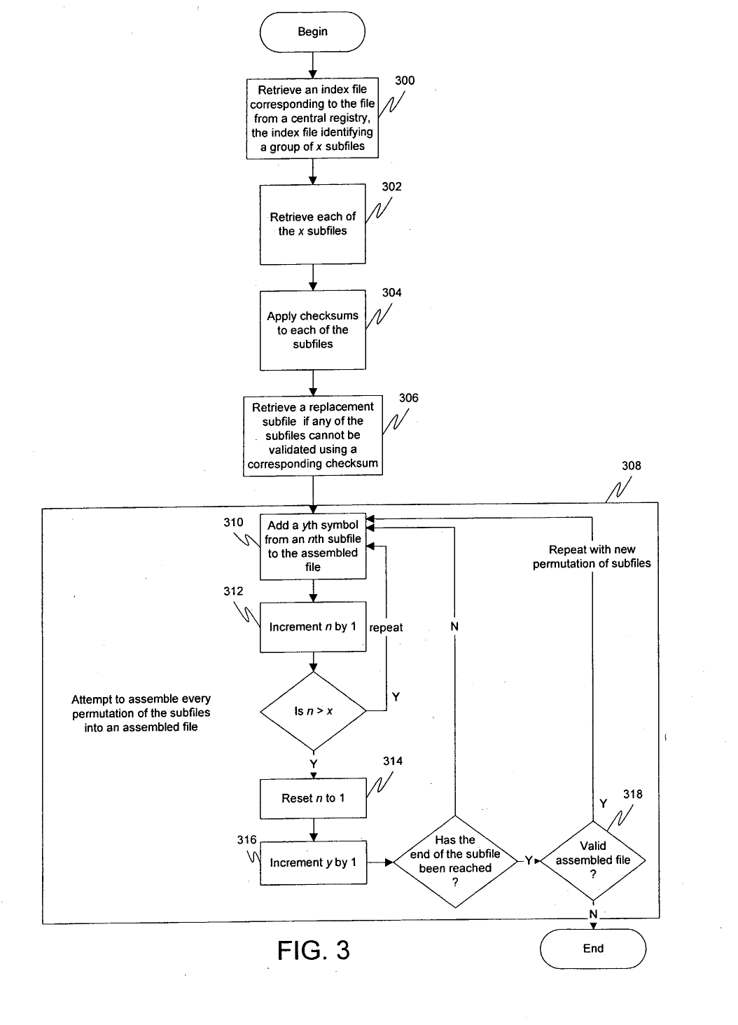

FIG. 3 is a flow diagram illustrating a method for retrieving a file in a computer network in accordance with an embodiment of the present invention. A bitstreaming size (the number of subfiles that will be generated from a file) may be represented by x with n being a counter initially set to 1. Additionally, y is a counter initially set to 0. At 300, an index file corresponding to the file may be retrieved from a central registry, the index file identifying a group of x subfiles. The index file may also indicate the location of each of the subfiles, a file size for each of the subfiles, and/or a checksum for each of the subfiles. At 302, each of the x subfiles may be retrieved. The locations may be utilized for this purpose if necessary. At 304, the checksums may be applied to each of the subfiles. At 306, a replacement subfile may be retrieved if any of the subfiles cannot be validated using a corresponding checksum. At 308, every permutation of the subfiles may be attempted to be assembled into an assembled file, until the assembled file is valid. This may include the following. At 310, a yth symbol from an nth subfile may be added to the assembled file. The term symbol is intended to indicate any sized data set. At 312, n may be incremented by one. 314 and 316 may be repeated until n>x. At 318, n may be reset to 1. At 320, y may be incremented by 1. 310, 312, 314, and 316 may be repeated until the end of each subfile is reached. At 318, it may be determined if the assembled file is valid. If not, then 310-316 may be repeated with a different permutation of subfiles.

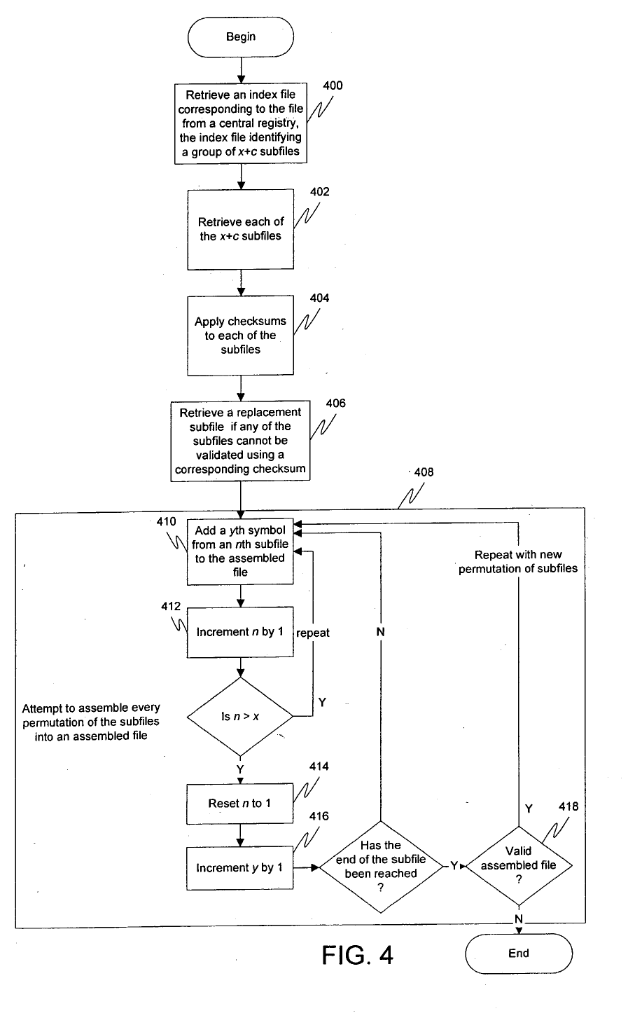

FIG. 4 is a flow diagram illustrating a method for retrieving a file in a computer network in accordance with another embodiment of the present invention. In this embodiment, error-correcting capabilities are provided through a Huffman algorithm. A bitstreaming size (the number of subfiles that will be generated from a file) may be represented by x with n being a counter initially set to 1. Additionally, y is a counter initially set to 0. A number of symbols that were added to existing symbols in order to provide error-correcting capabilities may be denoted as c. At 400, an index file corresponding to the file may be retrieved from a central registry, the index file identifying a group of x+c subfiles. The index file may also indicate the location of each of the subfiles, a file size for each of the subfiles, and/or a checksum for each of the subfiles. At 402, each of the x+c subfiles may be retrieved. The locations may be utilized for this purpose if necessary. At 404, the checksums may be applied to each of the subfiles. At 406, a replacement subfile may be retrieved if any of the subfiles cannot be validated using a corresponding checksum. At 408, every permutation of the subfiles may be attempted to be assembled into an assembled file, until the assembled file is valid. This may include the following. At 410, a yth symbol from an nth subfile may be added to the assembled file. The term symbol is intended to indicate any sized data set. At 412, n may be incremented by one. 414 and 416 may be repeated until n>x+c. At 418, n may be reset to 1. At 420, y may be incremented by 1. 410, 412, 414, and 416 may be repeated until the end of each subfile is reached. At 418, it may be determined if the assembled file is valid. An assembled file may be valid if c symbols out of every x+c symbols in the assembled file correspond to a valid error-correcting code, such as a Huffman code. If not, then 410-416 may be repeated with a different permutation of subfiles.

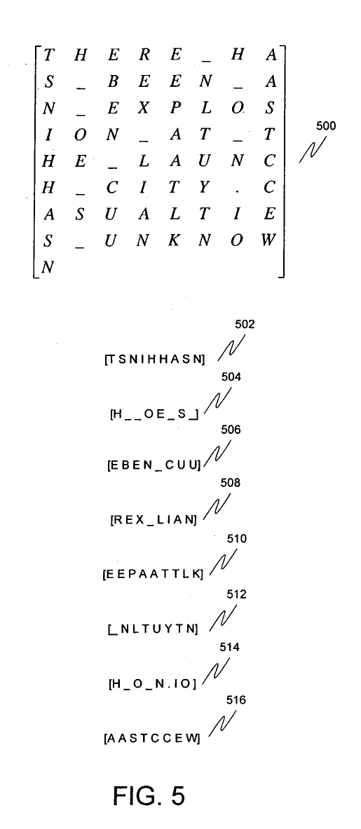

FIG. 5 is an example is provided in order to illustrate how the present invention may work. In this example, for ease of reading, characters are utilized as symbols, as opposed to the more typical bits. The bitstreaming size here may be 8. Here, the following message may be indicated “There has been an explosion at the launch city. Casualties unknown”. 500 indicates how this message appears in a two-dimensional array of width 8. Subfiles for this message may be created by taking the first symbol and putting it in a first subfile, then the second in a second, etc. until the symbol in the 8th location is found (the 9th symbol, which is greater than x). Then the same process occurs for the next set of x symbols beginning with the offset of 7 (which is n−1). This results in the subfiles 502-516. An index file identifying these subfiles may be created and stored in a central registry. A user may then read the message by first retrieving the index file from the registry. Then, the subfiles may be retrieved using the identifications in the index file. Then, each permutation of the subfiles may be attempted to be assembled until a valid message is found.

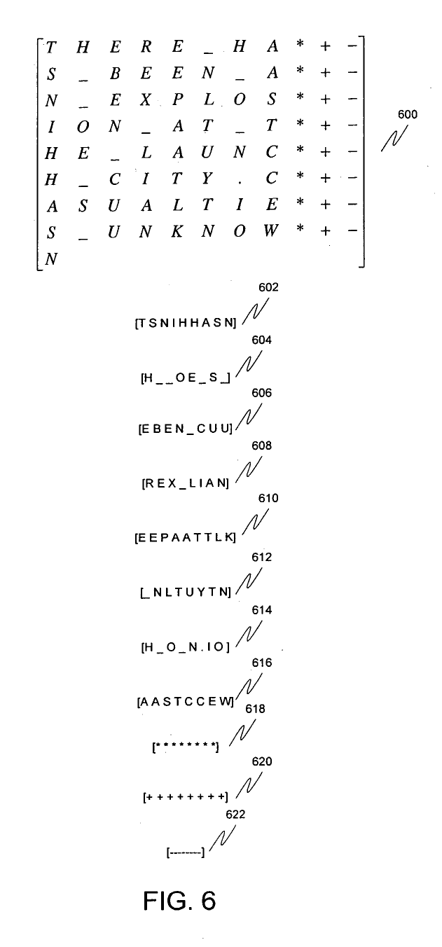

FIG. 6 is another example is provided in order to illustrate how the present invention may work. In this example, for ease of reading, characters are utilized as symbols, as opposed to the more typical bits. The bitstreaming size here may be 8. However, in this example, 3 error-correcting symbols are added to each 8 symbols. 600 indicates how this message appears in a two-dimensional array of width 11 (8+3). Subfiles for this message may be created by taking the first symbol and putting it in a first subfile, then the second in a second, etc. until the symbol in the 11th location is found (the 12th symbol, which is greater than x). Then the same process occurs for the next set of x symbols beginning with the offset of 10 (which is n−1). This results in the subfiles 602-622. An index file identifying these subfiles may be created and stored in a central registry. A user may then read the message by first retrieving the index file from the registry. Then, the subfiles may be retrieved using the identifications in the index file. Then, each permutation of the subfiles may be attempted to be assembled until a valid message is found.

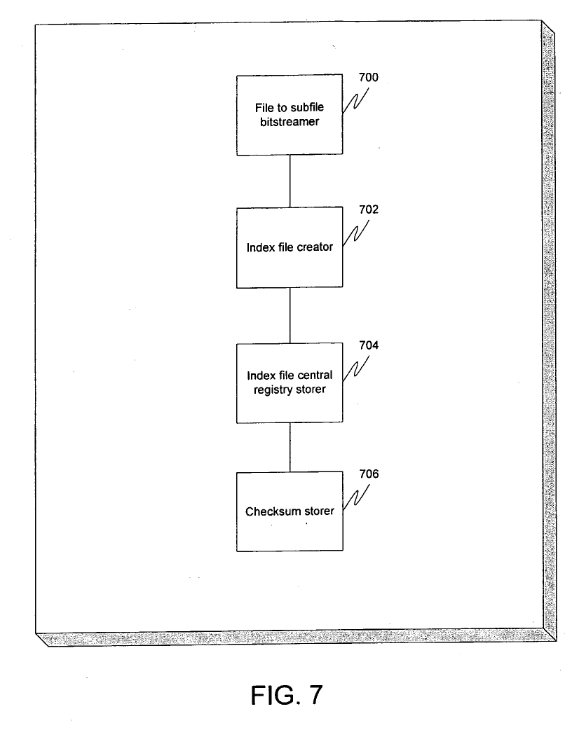

FIG. 7 is a block diagram illustrating an apparatus for bitstreaming a data file in accordance with an embodiment of the present invention. A bitstreaming size (the number of subfiles that will be generated from a file) may be represented by x with n being a counter initially set to 1. A file to subfile bitstreamer 700 may create an nth subfile containing every xth symbol of the data file from an offset of n−1 may be created. The term symbol is intended to indicate any sized data set. Typically, each symbol will be a bit, therefore the data file is bitstreamed by taking every xth bit, but one of ordinary skill in the art will recognize that the symbol may be of a different size, such as a byte or a character. N maybe incremented by 1. The creating and incrementing may be repeated until n>x. An index file creator 702 coupled to the file to subfile bitstreamer 700 may create an index file identifying each of the subfiles. The index file may further indicate the location of each subfile, if that is not readily apparent from the identification. An index file central registry storer 704 coupled to the index file creator 702 may store the index file in a central registry. A checksum storer 706 couple to the index file central registry storer 704 may store an MD5 checksum for each of the subfiles.

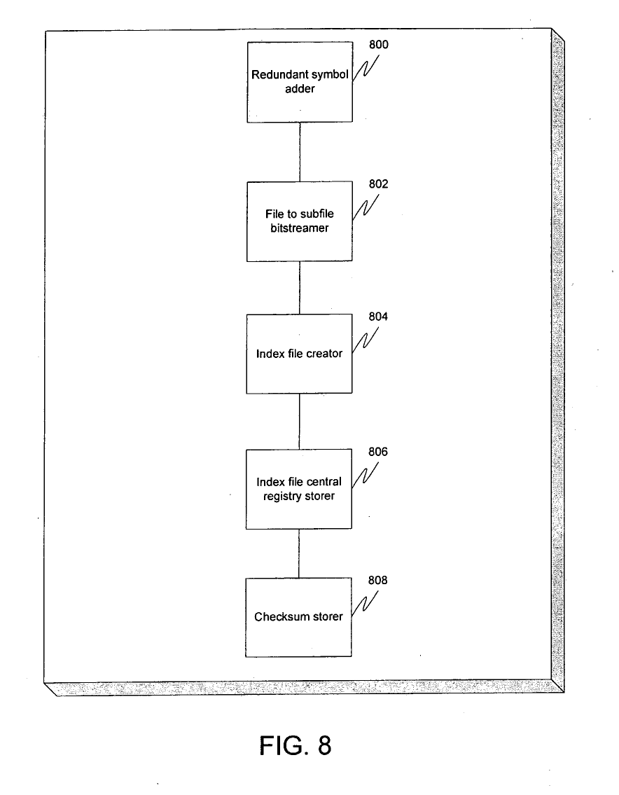

FIG. 8 is a block diagram illustrating an apparatus for bitstreaming a data file in accordance with another embodiment of the present invention. In this embodiment, error-correcting capabilities are provided through a Huffman algorithm. A bitstreaming size (the number of subfiles that will be generated from a file) may be represented by x with n being a counter initially set to 1. A number of symbols to add in order to provide error-correcting capabilities may be denoted as c. A redundant symbol adder 800 may add c redundant symbols to each x symbols in the data file. A file to subfile bitstreamer 802 coupled to the redundant symbol adder 800 may create an nth subfile containing every (x+c)th symbol of the data file from an offset of n−1 may be created. The term symbol is intended to indicate any sized data set. Typically, each symbol will be a bit, therefore the data file is bitstreamed by taking every (x+c)th bit, but one of ordinary skill in the art will recognize that the symbol may be of a different size, such as a byte or a character.

N maybe incremented by 1. The creating and incrementing may be repeated until n>x+c. An index file identifying each of the subfiles may be created. The index file may further indicate the location of each subfile, if that is not readily apparent from the identification. The index file may be stored in a central registry. Each of the subfiles may be stored on a server. At A file size for each of the subfiles may be stored on the server. At 214, an MD5 checksum may be stored for each of the subfiles.

An index file creator 804 coupled to the file to subfile bitstreamer 802 may create an index file identifying each of the subfiles. The index file may further indicate the location of each subfile, if that is not readily apparent from the identification. An index file central registry storer 806 coupled to the index file creator 804 may store the index file in a central registry. A checksum storer 808 couple to the index file central registry storer 806 may store an MD5 checksum for each of the subfiles.

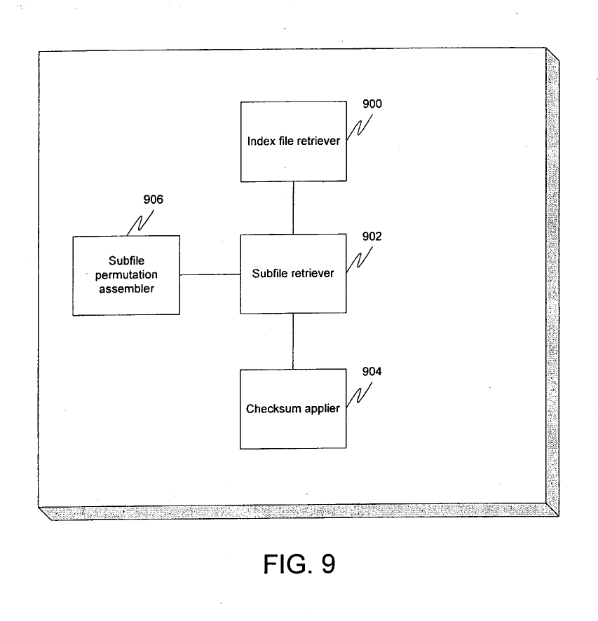

FIG. 9 is a block diagram illustrating an apparatus for retrieving a file in a computer network in accordance with an embodiment of the present invention. A bitstreaming size (the number of subfiles that will be generated from a file) may be represented by x with n being a counter initially set to 1. Additionally, y is a counter initially set to 0. An index file retriever 900 may retrieve an index file corresponding to the file from a central registry, the index file identifying a group of x subfiles. The index file may also indicate the location of each of the subfiles, a file size for each of the subfiles, and/or a checksum for each of the subfiles. A subfile retriever 902 coupled to the index file retriever 900 may retrieve each of the x subfiles. The locations may be utilized for this purpose if necessary. A checksum applier 904 coupled to the subfile retriever 902 may apply checksums to each of the subfiles. A replacement subfile may be retrieved if any of the subfiles cannot be validated using a corresponding checksum. A subfile permutation assembler 906 coupled to the subfile retriever 902 may attempt to assemble every permutation of the subfiles into an assembled file, until the assembled file is valid. This may include the following. A yth symbol from an nth subfile may be added to the assembled file. The term symbol is intended to indicate any sized data set. N may be incremented by one. These last two may be repeated until n>x. N may be reset to 1. Y may be incremented by 1. These last four may be repeated until the end of each subfile is reached. It may be determined if the assembled file is valid. If not, then the last five may be repeated with a different permutation of subfiles.

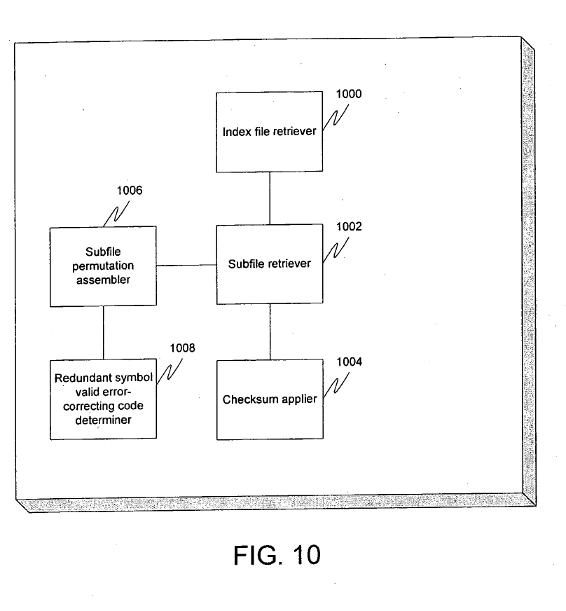

FIG. 10 is a block diagram illustrating an apparatus for retrieving a file in a computer network in accordance with another embodiment of the present invention. In this embodiment, error-correcting capabilities are provided through a Huffman algorithm. A bitstreaming size (the number of subfiles that will be generated from a file) may be represented by x with n being a counter initially set to 1. Additionally, y is a counter initially set to 0. A number of symbols that were added to existing symbols in order to provide error-correcting capabilities may be denoted as c. An index file retriever 1000 may retrieve an index file corresponding to the file may be retrieved from a central registry, the index file identifying a group of x+c subfiles. The index file may also indicate the location of each of the subfiles, a file size for each of the subfiles, and/or a checksum for each of the subfiles. A subfile retriever 1002 coupled to the index file retriever 1000 may retrieve each of the x+c subfiles. The locations may be utilized for this purpose if necessary. A checksum applier 1004 coupled to the subfile retriever 1002 may apply checksums to each of the subfiles. A replacement subfile may be retrieved if any of the subfiles cannot be validated using a corresponding checksum. A subfile permutation assembler 1006 coupled to the subfile retriever 1002 may attempt to assemble every permutation of the subfiles into an assembled file, until the assembled file is valid. This may include the following. A yth symbol from an nth subfile may be added to the assembled file. The term symbol is intended to indicate any sized data set. N may be incremented by one. The last two may be repeated until n>x+c. Then, n may be reset to 1. Y may be incremented by 1. The last four may be repeated until the end of each subfile is reached. A redundant symbol valid error-correcting code determiner 1008 coupled to the subfile permutation assembler 1006 may determine if the assembled file is valid. An assembled file may be valid if c symbols out of every x+c symbols in the assembled file correspond to a valid error-correcting code, such as a Huffman code. If not, then this mini-process may be repeated with a different permutation of subfiles.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for bitstreaming a data file, wherein x represents a bitstreaming size and n is initially set to 1, the method comprising:
creating an nth subfile containing every xth symbol of the data file from an offset of n−1;
incrementing n by 1;
repeating said creating and incrementing until n>x;
creating an index file identifying each of said subfiles; and
storing said index file in a central registry.

2. The method of claim 1, further comprising:
storing each of said subfiles on a server.

3. The method of claim 2, further comprising:
storing a file size for each of said subfiles on said server.

4. The method of claim 3, further comprising:
storing a checksum for each of said subfiles on said server.

5. The method of claim 4, wherein said checksum is an MD5 checksum.

6. The method of claim 1, wherein every xth symbol is a bit.

7. The method of claim 1, wherein said index file further indicates a location for each of said subfiles.

8. A method for bitstreaming a data file, wherein x represents a bitstreaming size, c represents a number of symbols to add to existing symbols in order to provide error-correcting capabilities, and n is initially set to 1, the method comprising:
adding c redundant symbols to each x symbols in said data file;
creating an nth subfile containing every (x+c)th symbol of the data file from an offset of incrementing n by 1;
repeating said creating and incrementing until n>x+c;
creating an index file identifying each of said subfiles; and
storing said index file in a central registry.

9. The method of claim 8, further comprising:
storing each of said subfiles on a server.

10. The method of claim 9, further comprising:
storing a file size for each of said subfiles on said server.

11. The method of claim 10, further comprising:
storing a checksum for each of said subfiles on said server.

12. The method of claim 11, wherein said checksum is an MD5 checksum.

13. The method of claim 8, wherein every (x+c)th symbol is a bit.

14. The method of claim 8, wherein said index file further indicates a location for each of said subfiles.

15. A method for retrieving a file in a computer network, wherein x is a bitstreaming size, y is initially set to 0 and n is initially set to 1, comprising:
retrieving an index file corresponding to said file from a central registry, said index file identifying a group of x subfiles;
retrieving each of said x subfiles;
attempting to assemble every permutation of said subfiles into an assembled file until said assembled file is valid, said assembling including:
adding an yth symbol from said nth subfile to said assembled file;
incrementing n by 1;
repeating said adding and said incrementing until n>x;
resetting n to 1;
incrementing y by 1; and
repeating said adding, incrementing n, repeating, resetting, and incrementing y until an end of each subfile is reached.

16. The method of claim 15, wherein said index file indicates a location of each of each of said x subfiles and said retrieving each of said x subfiles includes retrieving each of said x subfiles using said locations.

17. The method of claim 15, further comprising retrieving a file size for each of said subfiles.

18. The method of claim 17, further comprising retrieving a checksum for each of said subfiles.

19. The method of claim 18, wherein said checksums are MD5 checksums.

20. The method of claim 18, further comprising the following before said attempting to assemble:
applying said checksums to each of said subfiles;
retrieving a replacement subfile if any of said subfiles cannot be validated using a corresponding checksum.

21. A method for retrieving a file in a computer network, wherein x is a bitstreaming size, c represents a number of symbols added to existing symbols in order to provide error-correcting capabilities, y is initially set to 0 and n is initially set to 1, comprising:
retrieving an index file corresponding to said file from a central registry, said index file identifying a group of x+c subfiles;
retrieving each of said x+c subfiles;
attempting to assemble every permutation of said subfiles into an assembled file until said assembled file is valid, said assembling including:
adding an yth symbol from said nth subfile to said assembled file;
incrementing n by 1;
repeating said adding and said incrementing until n>x+c;
resetting n to 1;
incrementing y by 1;
repeating said adding, incrementing n, repeating, resetting, and incrementing y until an end of each subfile is reached; and
wherein said assembled file is valid if c symbols out of every x+c symbols in said assembled file correspond to a valid error-correcting code.

22. The method of claim 21, wherein said valid error-correcting code is a valid Huffman code.

23. The method of claim 21, wherein said index file indicates a location of each of each of said x subfiles and said retrieving each of said x subfiles includes retrieving each of said x subfiles using said locations.

24. The method of claim 21, further comprising retrieving a file size for each of said subfiles.

25. The method of claim 24, further comprising retrieving a checksum for each of said subfiles.

26. The method of claim 25, wherein said checksums are MD5 checksums.

27. The method of claim 26, further comprising the following before said attempting to assemble:
applying said checksums to each of said subfiles;
retrieving a replacement subfile if any of said subfiles cannot be validated using a corresponding checksum.

28. An apparatus for bitstreaming a data file, the apparatus comprising:
a file to subfile bitstreamer;
an index file creater coupled to said file to subfile bitstreamer; and
an index file central registry storer coupled to said index file creator.

29. The apparatus of claim 28, further comprising a checksum storer coupled to said index file central registry storer.

30. The apparatus of claim 28, further comprising a redundant symbol adder coupled to said file to subfile bitstreamer.

31. An apparatus for retrieving a file in a computer network, the apparatus comprising:
an index file retriever;
a subfile retriever coupled to said index file retriever; and
a subfile permutation assembler coupled to said subfile retriever.

32. The apparatus of claim 31, further comprising a checksum applier coupled to said subfile retriever.

33. The apparatus of claim 31, further comprising a redundant symbol valid error-collecting code determiner coupled to said subfile permutation assembler.

34. An apparatus for bitstreaming a data file, wherein x represents a bitstreaming size and n is initially set to 1, the apparatus comprising:
means for creating an nth subfile containing every xth symbol of the data file from an offset of n−1;
means for incrementing n by 1;
means for repeating said creating and incrementing until n>x;
means for creating an index file identifying each of said subfiles; and
means for storing said index file in a central registry.

35. The apparatus of claim 34, further comprising:
means for storing each of said subfiles on a server.

36. The apparatus of claim 35, further comprising:
means for storing a file size for each of said subfiles on said server.

37. The apparatus of claim 36, further comprising:
means for storing a checksum for each of said subfiles on said server.

38. The apparatus of claim 37, wherein said checksum is an MD5 checksum.

39. The apparatus of claim 34, wherein every xth symbol is a bit.

40. The apparatus of claim 34, wherein said index file further indicates a location for each of said subfiles.

41. An apparatus for bitstreaming a data file, wherein x represents a bitstreaming size, c represents a number of symbols to add to existing symbols in order to provide error-correcting capabilities, and n is initially set to 1, the apparatus comprising:
means for adding c redundant symbols to each x symbols in said data file;
means for creating an nth subfile containing every (x+c)th symbol of the data file from an offset of n−1;
means for incrementing n by 1;
means for repeating said creating and incrementing until n>x+c;
means for creating an index file identifying each of said subfiles; and
means for storing said index file in a central registry.

42. The apparatus of claim 41, further comprising:
means for storing each of said subfiles on a server.

43. The apparatus of claim 42, further comprising:
means for storing a file size for each of said subfiles on said server.

44. The apparatus of claim 43, further comprising:
storing a checksum for each of said subfiles on said server.

45. The apparatus of claim 44, wherein said checksum is an MD5 checksum.

46. The apparatus of claim 41, wherein every (x+c)th symbol is a bit.

47. The apparatus of claim 41, wherein said index file further indicates a location for each of said subfiles.

48. An apparatus for retrieving a file in a computer network, wherein x is a bitstreaming size, y is initially set to 0 and n is initially set to 1, comprising:
means for retrieving an index file corresponding to said file from a central registry, said index file identifying a group of x subfiles;
means for retrieving each of said x subfiles;
means for attempting to assemble every permutation of said subfiles into an assembled file until said assembled file is valid, said means for assembling including:
means for adding an yth symbol from said nth subfile to said assembled file;
means for incrementing n by 1;
means for repeating said adding and said incrementing until n>x;
means for resetting n to 1;
means for incrementing y by 1; and
means for repeating said adding, incrementing n, repeating, resetting, and incrementing y until an end of each subfile is reached.

49. The apparatus of claim 48, wherein said index file indicates a location of each of each of said x subfiles and said means for retrieving each of said x subfiles includes means for retrieving each of said x subfiles using said locations.

50. The apparatus of claim 48, further comprising means for retrieving a file size for each of said subfiles.

51. The apparatus of claim 50, further comprising means for retrieving a checksum for each of said subfiles.

52. The apparatus of claim 51, wherein said checksums are MD5 checksums.

53. The apparatus of claim 51, further comprising:
means for applying said checksums to each of said subfiles;
means for retrieving a replacement subfile if any of said subfiles cannot be validated using a corresponding checksum.

54. An apparatus for retrieving a file in a computer network, wherein x is a bitstreaming size, c represents a number of symbols added to existing symbols in order to provide error-correcting capabilities, y is initially set to 0 and n is initially set to 1, comprising:
means for retrieving an index file corresponding to said file from a central registry, said index file identifying a group of x+c subfiles;
means for retrieving each of said x+c subfiles;
means for attempting to assemble every permutation of said subfiles into an assembled file until said assembled file is valid, said means for assembling including:
means for adding an yth symbol from said nth subfile to said assembled file;
means for incrementing n by 1;
means for repeating said adding and said incrementing until n>x+c;
means for resetting n to 1;
means for incrementing y by 1;
means for repeating said adding, incrementing n, repeating, resetting, and incrementing y until an end of each subfile is reached; and
wherein said assembled file is valid if c symbols out of every x+c symbols in said assembled file correspond to a valid error-correcting code.

55. The apparatus of claim 54, wherein said valid error-correcting code is a valid Huffman code.

56. The apparatus of claim 54, wherein said index file indicates a location of each of each of said x subfiles and said means for retrieving each of said x subfiles includes means for retrieving each of said x subfiles using said locations.

57. The apparatus of claim 54, further comprising means for retrieving a file size for each of said subfiles.

58. The apparatus of claim 57, further comprising means for retrieving a checksum for each of said subfiles.

59. The apparatus of claim 58, wherein said checksums are MD5 checksums.

60. The apparatus of claim 59, further comprising:
means for applying said checksums to each of said subfiles;
means for etrieving a replacement subfile if any of said subfiles cannot be validated using a corresponding checksum.

61. A program storage device readable by a machine, tangibly embodying a program of instructions executable by the machine to perform a method for bitstreaming a data file, wherein x represents a bitstreaming size and n is initially set to 1, the method comprising:
creating an nth subfile containing every xth symbol of the data file from an offset of n−1;
incrementing n by 1;
repeating said creating and incrementing until n>x;
creating an index file identifying each of said subfiles; and
storing said index file in a central registry.

62. A program storage device readable by a machine, tangibly embodying a program of instructions executable by the machine to perform a method for bitstreaming a data file, wherein x represents a bitstreaming size, c represents a number of symbols to add to existing symbols in order to provide error-correcting capabilities, and n is initially set to 1, the method comprising:
adding c redundant symbols to each x symbols in said data file;
creating an nth subfile containing every (x+c)th symbol of the data file from an offset of n−1;
incrementing n by 1;
repeating said creating and incrementing until n>x+c;
creating an index file identifying each of said subfiles; and
storing said index file in a central registry.

63. A program storage device readable by a machine, tangibly embodying a program of instructions executable by the machine to perform a method for retrieving a file in a computer network, wherein x is a bitstreaming size, y is initially set to 0 and n is initially set to 1, comprising:
retrieving an index file corresponding to said file from a central registry, said index file identifying a group of x subfiles;
retrieving each of said x subfiles;
attempting to assemble every permutation of said subfiles into an assembled file until said assembled file is valid, said assembling including:
adding an yth symbol from said 11th subfile to said assembled file;
incrementing n by 1;
repeating said adding and said incrementing until n>x;
resetting n to 1;
incrementing y by 1; and
repeating said adding, incrementing n, repeating, resetting, and incrementing y until an end of each subfile is reached.

64. A program storage device readable by a machine, tangibly embodying a program of instructions executable by the machine to perform a method for retrieving a file in a computer network, wherein x is a bitstreaming size, c represents a number of symbols added to existing symbols in order to provide error-correcting capabilities, y is initially set to 0 and it is initially set to 1, comprising:
retrieving an index file corresponding to said file from a central registry, said index file identifying a group of x+c subfiles;
retrieving each of said x+c subfiles;
attempting to assemble every permutation of said subfiles into an assembled file until said assembled file is valid, said assembling including:
adding an yth symbol from said nth subfile to said assembled file;
incrementing n by 1;
repeating said adding and said incrementing until n>x+c;
resetting n to 1;
incrementing y by 1;
repeating said adding, incrementing n, repeating, resetting, and incrementing y until an end of each subfile is reached; and
wherein said assembled file is valid if c symbols out of every x+c symbols in said assembled file correspond to a valid error-correcting code.
